(19) United States
(12) Patent Application Publication
(10) Pub. No.: US 2006/0012183 A1
(43) Pub. Date: Jan. 19, 2006

(54) Rail car door opener

(76) Inventors: David Marchiori, San Antonio, TX (US); Ralph A. Marchiori, San Antonio, TX (US)

Correspondence Address: David Marchiori, 5896 Old Camp Bullis Rd., San Antonio, TX, 78257, US

(21) Appl. No.: 10/894,087

(22) Filed: Jul. 19, 2004

(51) Int. Cl. E05C 5/00

(52) U.S. Cl. 292/63

(57) ABSTRACT

A servo that is attachabley secured to the rail car frame at each door lock that is connected to the latch via a draw bar with sufficient modulus to withstand the repeated force required to move the latch thus opening the door. The servo provides a pulling action with the motive force being pneumatic pressure but not limited to pneumatic whereas hydraulic or electric energy can be supplied to the servo providing the motive force to pull the draw bar attached to the latch, that when said servo provides a pulling force sufficient to over come the friction ot the latch to the striker plate the latch moves in a upward direction thus releasing the door to open. A second element of the servo is to provide a pushing action via the draw bar to the door latch to drive it all the way into the closed position.

### FIELD OF THE INVENTION

The present invention relates to opening rail cars with Wine Door Lock type locks and, more particularly, to a attachabley secured device that automates the opening of said lock. The current method of opening said lock requies a person to rotate the safety cam that provides a interference to the latch that retains the door of the rail car in a closed position. Once the safety cam is rotated to remove the interference related to the movement of the latch the personnel opening the door latch is further required to strike the latch in a upward motion with a sledge hammer often with repeated blows. The inventors in this novel approach provide a motive force other than human to open the latch. This invention generally relates to a method and apparatus for opening railroad car doors, and more specifically to a method and apparatus for opening doors of hopper cars, wherein the doors are located on the bottom of the railroad car.

### BACKGROUND OF THE INVENTION

The current procedure used for opening of the Wine Door Latch requires a human to deliver a precise blow with a sledge hammer in a upward motion that is directed at the latch in order to move the latch thus releasing the door to open thus upon opening with dangerous force the door is driven downward word by the weight of the commodity in the rail car. The human technician is exposed to a close proximity of the release of energy as the door opens creating an environment for a potential accident if the technican would trip into the path of the door, additionally when the door opens the rapid movement of the commodity creates air born particle emissions that the human can not escape from.

U.S. Pat. No. 4,843,974 to Ritter describes a car door opener for use on a railroad hopper car having bottom discharge doors. In Ritter, an elongated beam assembly along the bottom of the car, door operating levers to open and close the doors connected to the beam assembly and doors, and lost motion timing connections in the beam assembly which permits displacement of beam sections to open and close pairs or sets of doors in a sequential but substantially simultaneous and automatic order so as to permit reduction of air pressure required to open the doors, or permit use of smaller diameter air cylinder.

The Ritter method requires one large cylinder and an excessive amount of mechanical linkages and bell cranks. If the large cylinder fails none of the doors can be opened.

It is therefore an object of the invention to open Wine Door Lock latches with a servo that is attachabley secured to the rail car frame member and said servo linked to the latch via a draw bar to transmit the servo's pulling force to the latch providing the motive force nessecary to open the latch releasing the door to open thus dispensing the commodity in the rail car downward through the grating present at dump sites into the hopper below the surface.

It is another object of the invention to provide a alternate latch locking cam that is an intergal part of the servo that would allow remote unlocking of the provided alternate safety cam via a motive energy of pneumatics but not limited to pneumatics.

It is another object of the invention to provide a alternate door opening device that would allow the technician to be away from the discharge of energy area.

It is another object of the invention to allow the techincian to be away form the area of high concentrations of air borne particles emitted during the release of the commodity

### SUMMARY OF THE INVENTION

In accordance with the present invention, there is provided, a servo that is attachabley secured to the rail car frame at each door lock that is connected to the latch via a draw bar with sufficient modulus to withstand the repeated force required to move the latch thus opening the door. The servo provides a pulling action with the motive force being pneumatic pressure but not limited to pneumatic whereas hydraulic or electric energy can be supplied to the servo providing the motive force to pull the draw bar attached to the latch, that when said servo provides a pulling force sufficient to over come the friction ot the latch to the striker plate the latch moves in a upward direction thus releasing the door to open. Attached to this Patent Application is a compact disc CD with a movie clip namely (Mov02022.mpg) and two digitial pictures namely Dsc01999.jpg and Dsc02000.jpg).

### BRIEF DESCRIPTION OF THE DRAWINGS

A complete understanding of the present invention may be obtained by reference to the accompanying drawings, when considered in conjunction with the subsequent, detailed description, in which:

FIG. 1A is a front view of a shows a rail car door opener coupled to each hopper door on the railroad car.;

FIG. 1B is a FIG. 1B shows the opening of a first door;

FIG. 1C is a FIG. 1C shows the opening of a second door.;

FIG. 1D is a FIG. 1D shows the opening of a third door.;

FIG. 2A is an In one particular embodiment of the invention, depicted in FIG. 2A, a door opener for opening the doors of a railroad hopper car comprises a door opener assembly coupled on each side of the car. The door opener assemblies are coupled to the car in an enabling position related to the latch 101, and therefore allowing the activation of servo 100 to transmit the pulling force of the servo via the connecting element 102 to further transmit the pulling force to the latch 101 resultant in the forced movement of the latch 101 allowing the opening of the doors to dispatch a load of product. In other particular embodiments, the door opener assemblies may only be needed on one side of the car.;

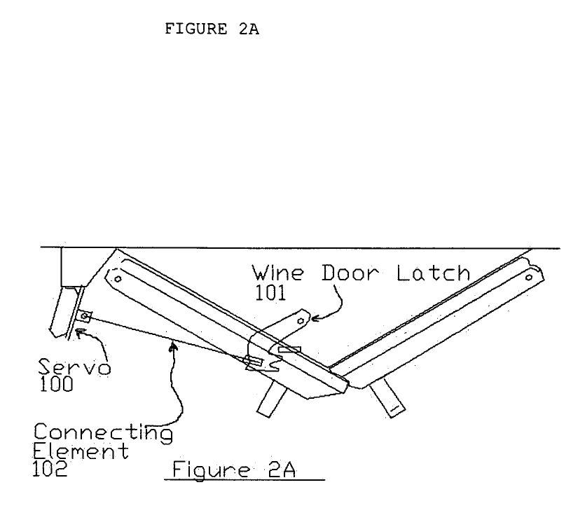

FIG. 2B is a The servo of the particular embodiment of FIG. 2B is configured as a cylinder that creates a pushing force against a bell crank to produce a resulting pulling force directed to the latch to open the doors. As depicted in FIG. 2B, the bell crank may include multiple pivot location holes to adjust the multiplication of force applied. Further, the motive force of the opener element may be freely varied between any combination of mechanical, electrical, pneumatic and fluid-driven servo system. Additionally, the servo may also comprise a hammer pulser to aid in releasing stuck latches. The hammer pulser would create shock waves in addition to the applied pull created by the servo.; and

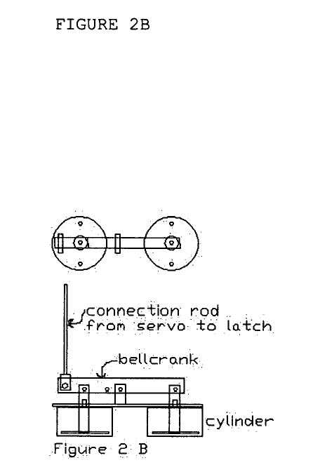

FIG. 2C is a FIG. 2C, the servo may further include a locking mechanism to replace the wine door latch cam lock, so that the process of disengaging the safety latch on the wine door latch is eliminated. A locking block may be configured to hold the door latch in a closed position until the cylinder is activated. Activating the cylinder moves the locking block in sequence with the air chamber of the cylinder for the latch opening action to be employed. This will allow for automatic opening of the bottom discharge doors.

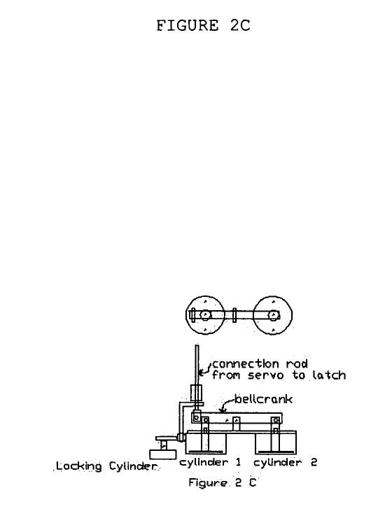

For purposes of clarity and brevity, like elements and components will bear the same designations and numbering throughout the FIGURES.

### DESCRIPTION OF THE PREFERRED EMBODIMENT

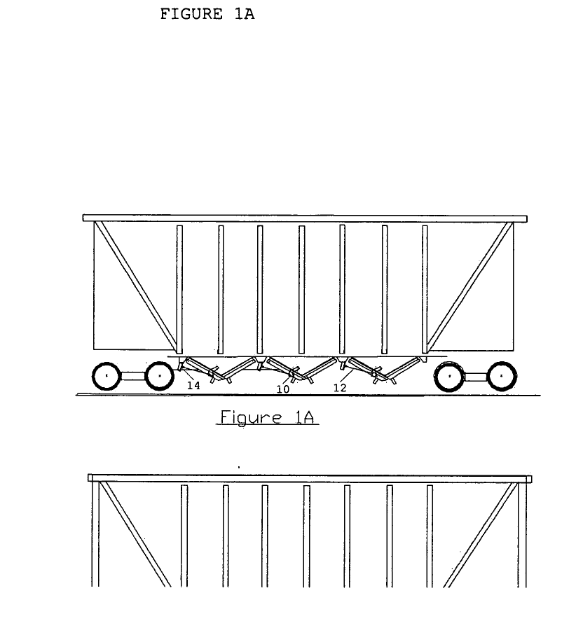

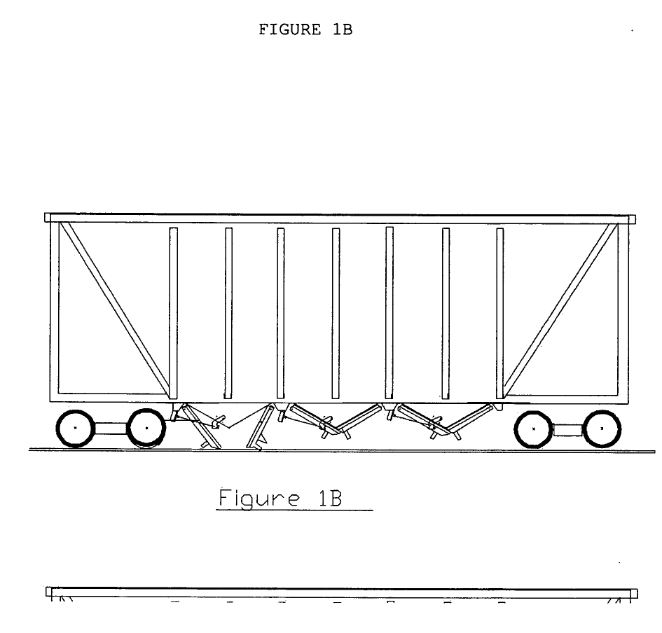

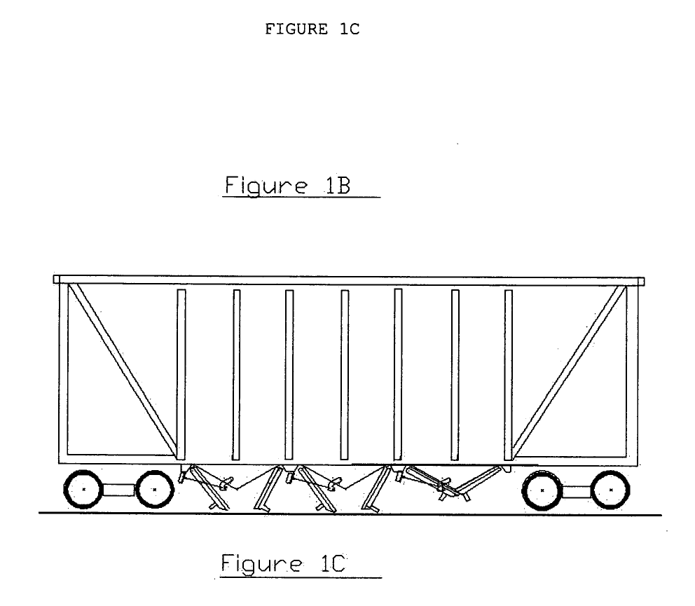

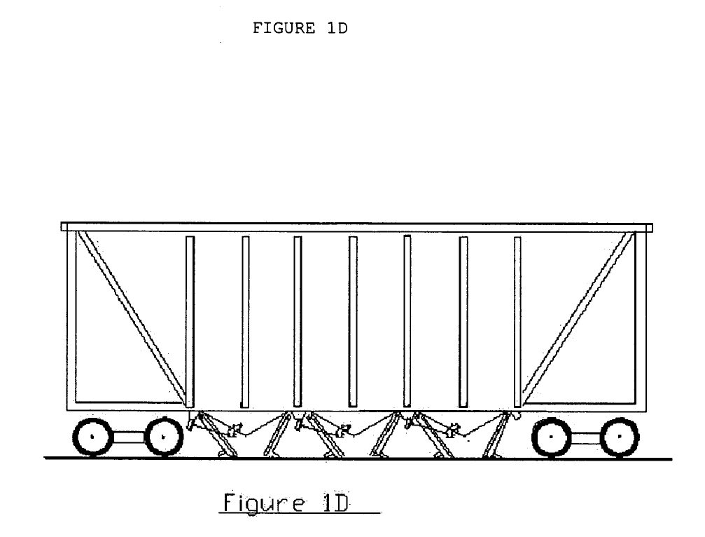

FIG. 1 is a perspective view of a.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A rail car door opener “previously filed as a provisional application registration # 42,342, docket # marc-0996” for this invention generally relates to a method and apparatus for opening railroad car doors, and more specifically to a method and apparatus for opening doors of hopper cars, wherein the doors are located on the bottom of the railroad car. comprising:
means for holds doors closed;
means for provides for connecting latch to servo, flexibly connected to said means for holds doors closed;
means for provides motive pulling force for opening latch and motive pushing force for closing the latch., flexibly connected to said means for provides for connecting latch to servo;
means for to drive the latch via the drawbar all the way closed.;
means for locking the wine door latch in the closed position. the cam lock provides a secondary method to insure that the latch can not open, rigidly connected to said means for holds doors closed; and
means for provides the interference over center mass that eliminates the possibility of the draw bar moving thus opening the latch of the rail car door, rotatably locked to said means for locking the wine door latch in the closed position. the cam lock provides a secondary method to insure that the latch can not open.

2. The rail car door opener “previously filed as a provisional application registration # 42,342, docket # marc-0996” in accordance with claim 1, wherein said means for holds doors closed comprises a door latch.

3. The rail car door opener “previously filed as a provisional application registration # 42,342, docket # marc-0996” in accordance with claim 1, wherein said means for provides for connecting latch to servo comprises a Draw Bar draw bar.

4. The rail car door opener “previously filed as a provisional application registration # 42,342, docket # marc-0996” in accordance with claim 1, wherein said means for provides motive pulling force for opening latch and motive pushing force for closing the latch. comprises a Servos servo.

5. The rail car door opener “previously filed as a provisional application registration # 42,342, docket # marc-0996” in accordance with claim 1, wherein said means for to drive the latch via the drawbar all the way closed. comprises a Return cylinder servo return.

6. The rail car door opener “previously filed as a provisional application registration # 42,342, docket # marc-0996” in accordance with claim 1, wherein said means for locking the wine door latch in the closed position. the cam lock provides a secondary method to insure that the latch can not open comprises a Cam Lock cam lock.

7. The rail car door opener “previously filed as a provisional application registration # 42,342, docket # marc-0996” in accordance with claim 1, wherein said means for provides the interference over center mass that eliminates the possibility of the draw bar moving thus opening the latch of the rail car door comprises a Cam lock pawl cam lock pawl.

8. A rail car door opener “previously filed as a provisional application registration # 42,342, docket # marc-0996” for this invention generally relates to a method and apparatus for opening railroad car doors, and more specifically to a method and apparatus for opening doors of hopper cars, wherein the doors are located on the bottom of the railroad car. comprising:
a door latch, for holds doors closed;
a Draw Bar draw bar, for provides for connecting latch to servo, flexibly connected to said Door Latch;
a Servos servo, for provides motive pulling force for opening latch and motive pushing force for closing the latch., flexibly connected to said Draw Bar;
a Return cylinder servo return, for to drive the latch via the drawbar all the way closed.;
a Cam Lock cam lock, for locking the wine door latch in the closed position. the cam lock provides a secondary method to insure that the latch can not open, rigidly connected to said Door Latch; and
a Cam lock pawl cam lock pawl, for provides the interference over center mass that eliminates the possibility of the draw bar moving thus opening the latch of the rail car door, rotatably locked to said Cam Lock.

9. The rail car door opener “previously filed as a provisional application registration # 42,342, docket # marc-0996” as recited in claim 8, wherein said door latch is Wine Door Latch.

10. A rail car door opener “previously filed as a provisional application registration # 42,342, docket # marc-0996” for this invention generally relates to a method and apparatus for opening railroad car doors, and more specifically to a method and apparatus for opening doors of hopper cars, wherein the doors are located on the bottom of the railroad car. comprising:
a Wine Door Latch door latch, for holds doors closed;
a Draw Bar draw bar, for provides for connecting latch to servo, flexibly connected to said Door Latch;
a Servos servo, for provides motive pulling force for opening latch and motive pushing force for closing the latch., flexibly connected to said Draw Bar;
a Return cylinder servo return, for to drive the latch via the drawbar all the way closed.;
a Cam Lock cam lock, for locking the wine door latch in the closed position. the cam lock provides a secondary method to insure that the latch can not open, rigidly connected to said Door Latch; and
a Cam lock pawl cam lock pawl, for provides the interference over center mass that eliminates the possibility of the draw bar moving thus opening the latch of the rail car door, rotatably locked to said Cam Lock.
